(19) United States
(12) Patent Application Publication
(10) Pub. No.: US 2004/0063601 A1
(43) Pub. Date: Apr. 1, 2004

(54) Method for manufacturing liquid gel automatic dishwashing detergent compositions comprising anhydrous solvent

(75) Inventors: Frank William Denome, Cincinnati, OH (US); Leslie Dawn Waits, Cincinnati, OH (US); Elizabeth Ann Alam, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/644,285

(22) Filed: Aug. 20, 2003

Related U.S. Application Data
(60) Provisional application No. 60/404,562, filed on Aug. 20, 2002.

(51) Int. Cl. C11D 17/00

(52) U.S. Cl. 510/407

(57) ABSTRACT

A method for manufacturing liquid gel anhydrous organic solvent compositions comprising sodium polyphosphate hexahydrate and a water-soluble dye which minimizes excessive pouch swelling and provides superior product color aesthetics.

### CROSS REFERENCE TO RELATED APPLICATION

This application claims the benefit of the filing date of U.S. Patent Application No. 60/404,562, filed Aug. 20, 2002.

### TECHNICAL FIELD

The present invention is in the field of dishwashing, in particular it relates to methods for manufacturing dishwashing and automatic dishwashing products suitable for cleaning soiled dishware, glassware, cookware and tableware.

### BACKGROUND OF THE INVENTION

The following references relate to the use of solvents in the automatic dishwashing context: JP-A-10,017,900; JP-A-11,117,000; and WO 02/16222 A1. For example, JP-A-10,017,900 discloses an automatic dishwashing auxiliary composition comprising non-ionic low foaming surfactant, organic solvent and water. The composition allegedly delivers detergency and drying benefits. JP-A-11,117,000 discloses a cleaning assistant composition for automatic dishwashing machines comprising surfactant, organic high-molecular polyelectrolyte, water-soluble solvent and water. WO 02/16222 A1 discloses water-soluble containers containing aqueous compositions that can comprise greater than 3% free water, surface active agents, enzymes, co-builder, organic solvents and co-solvents, dyes, and colourants.

The following references relate to the use of non-aqueous solvents in the automatic dishwashing context: U.S. Pat. No. 4,753,748; U.S. Pat. No. 5,094,771; U.S. Pat. No. 5,164,106; U.S. Pat. No. 5,169,553; U.S. Pat. No. 5,240,633; U.S. Pat. No. 5,318,715; U.S. Pat. No. 5,510,048; U.S. Pat. No. 5,527,483; U.S. Pat. No. 5,545,344; U.S. Pat. No. 5,618,465; U.S. Pat. No. 6,228,825 B1; EP. Patent No. 0611206; and WO 00/75272. For example, U.S. Pat. No. 4,753,748 discloses concentrated, stable, non-settling liquid detergent compositions comprising sodium tripolyphosphate and a water content of about 1%. U.S. Pat. No. 6,228,825 B1 discloses a non-aqueous liquid automatic dishwashing composition disposed in a water-soluble package comprising an organic solvent, an alkali metal phosphate builder salt, a non-ionic surfactant, a silicate, an alkali metal non-phosphate builder salt, and an antiredeposiiton agent. The composition delivers a dosable composition.

The problem with methods for manufacturing liquid gel anhydrous organic solvent compositions for bottle dosing and/or for pouch mold or pouch filling is that, without a specific order of addition, the single batch combination of the components results in a very thick product with an excessive yield value (e.g. greater than 35 Pa) that is very difficult to dose in a bottle or fill in a pouch mold or pouch. Light microscopy analysis of products made with high yield values described above show a high level of crystal structure formation in the matrices.

When non-aqueous solvent compositions having high yield values (e.g. greater than 35 Pa) are placed in water-soluble pouches for use in automatic dishwashing applications there is a problem with pouch swelling during storage. Not to be limited by theory, it is thought that the swelling is due to moisture uptake by the anhydrous solvent composition via mass transport through the pouch. Consequently, as water-soluble pouches become swollen they become tight to the touch. Their overall appearance and feel is not appealing to consumers. Thus, there is still the need for a method of manufacturing dosable liquid gel anhydrous organic solvent compositions for cleaning cookware and tableware in automatic dishwashing applications that avoids high yield values and the associated excessive pouch swelling when the compositions are packaged in water-soluble pouches.

It was surprisingly found that the critical step in avoiding excessive pouch swelling is in the way in which the solids are hydrated during manufacturing process. If the solids are allowed to dissolve, prior to hydration, they tend to re-crystallize during hydration. The net result is that the yield value of the gel-phase is significantly increased when re-crystallization occurs. XRD analytical data suggests that when hydration is completed in “in-situ” conditions (i.e. water added to the batch as outlined in the order of addition of the examples) the free water tends to bind to the carbonate instead of the phosphate. Consequently, it is believed that re-crystallization is decreased. The order of addition of the method of manufacture of the present invention results in lower yield values of products.

Furthermore, the types of dyes, pigments and colorants that are generally available for non-aqueous solvent compositions are generally limited to the water insoluble dyes, pigments and colorants which tend to limit the color selection of the non-aqueous solvent compositions to drab coloration making the water-soluble pouches less appealing to consumers. There is also a need for a method for manufacturing liquid gel anhydrous organic solvent compositions in bottle dosable form or water-soluble pouch form such that more pleasing color aesthetics are provided.

The present invention satisfies the identified needs by providing a method for manufacturing liquid gel anhydrous organic solvent compositions that minimize excessive pouch swelling and allow pleasing water-soluble dyes to be used.

### SUMMARY OF THE INVENTION

The present invention provides a method of manufacture of a dosable liquid gel anhydrous organic solvent composition comprising sodium tripolyphosphate hexahydrate and water-soluble dyes. The method of manufacture controls the free water content of the composition to reduce the effect of pouch swelling and to provide pleasing color aesthetics to the product when the composition is placed in a water-soluble pouch.

In one aspect of the present invention, a method for manufacturing an anhydrous organic solvent composition for use in automatic dishwashing, the steps of the method for manufacturing comprises: (a) providing an effective amount of a hydratable builder selected from the group consisting of sodium tripolyphosphate (STPP), sodium citrate, and mixtures thereof; (b) mixing said hydratable builder with an effective amount of water in a mixer to form a hydrated intermediate powder comprising hydrated builder, such that the phosphate, citrate, or mixture thereof in said hydrated intermediate powder is at least 30% hydrated by weight; (c) providing an effective amount of an organic solvent system; (d) mixing said hydrated intermediate powder and said organic solvent system together in a dispersion mill mix tank to reduce the particle size of the solids to between about 10 and about 70 microns as measured using a Hegman Gauge; (e) providing and adding a water-soluble dye to said dispersion mill mix tank; (f) providing and adding a thickener to said dispersion mill mix tank; (g) recirculating the components in said dispersion mill mix tank until said thickener and dye are fully dispersed in said composition; (h) allowing said composition to thicken; and (i) pouring or dosing said thickened composition in a container; wherein said composition is in the form of a liquid gel; and wherein the yield value of said composition has a range of from about 5 to about 35 Pa., preferably from about 10 to about 20, more preferably from about 12 to about 17, most preferably about 15.

The following description can be provided to enable any person skilled in the art to make and use the invention, and can be provided in the context of a particular application and its requirements. Various modifications to the embodiments will be readily apparent to those skilled in the art, and the generic principles defined herein can be applied to other embodiments and applications without departing from the spirit and scope of the invention. The present invention is not intended to be limited to the embodiments shown. Thus, since the following specific embodiments of the present invention are intended only to exemplify, but in no way limit, the operation of the present invention, the present invention is to be accorded the widest scope consistent with the principles, features and teachings disclosed herein.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document can be not to be construed as an admission that it can be prior art with respect to the present invention.

### DETAILED DESCRIPTION OF THE INVENTION

Definitions

“Cloud point”, as used herein, is a well known property of nonionic surfactants which is the result of the surfactant becoming less soluble with increasing temperature, the temperature at which the appearance of a second phase is observable is referred to as the “cloud point.” Cloud points are discussed in detail in Kirk Othmer, Encyclopedia of Chem. Tech, 3rd Edition, Vol. 17, pp 360-362.

“Detergent enzyme”, as used herein, means any enzyme having a cleaning, stain removing or otherwise beneficial effect in an organic solvent composition.

“Dishcare agent” means any type of composition or automatic dishwashing detergent additive that provides protective benefits to tableware during cleaning. Dishcare agents can include, but are not limited to, anti-corrosive agents, anti-tarnish agents, silvercare agents, metal care agents, and mixtures thereof.

“Tableware” means any type of dishware, glassware, cookware, and/or silverware, including, but not limited to, those made from glass, plastic, ceramic, metal, wood, porcelain, etc., as well as any type of silverware which includes all types made from metal, plastic, wood, glass, ceramic, porcelain, etc. Tableware can include, but is not limited to, cooking and eating utensils, dishes, cups, bowls, glasses, silverware, pots, pans, etc.

### Method of Manufacture

The anhydrous organic solvent composition can be manufactured in any physical form, e.g. liquid, paste, cream, gel, liquid gels and similarly the automatic dishwashing detergent composition can be in any of these forms. Preferably, however, both compositions are in the form of liquids and/or gels. The compositions used herein can be dispensed from any suitable device, such as bottles (pump assisted bottles, squeeze bottles), paste dispensers, capsules, multi-compartment bottles, multi-compartment capsules, pouches, and multi-compartment pouches. Pouches and multi-compartment pouches are preferred.

Preparation of Example I

The first step in this method for manufacture is a pre-hydration step. Water and sodium tripolyphosphate are mixed together in a mix tank to hydrate the STPP and form a hydrated intermediate powder. The amount of water to be added is determined by using the following chemical equation:

STPP+6H2O→STPP*6H2O

In this case, initially 22.37% STPP is added to a mix tank. The percentage of water can be calculated using the molecular weights of STPP (367.86 g/mol) and water (18 g/mol) in the equation above. The total percentage of water theoretically needed to convert the STPP to 100% STPP*6H2O is calculated to be about 6.57%. The percentage of water required will depend on whether additional water sources are added to the composition. For example, a stock solution that comprises less than 100% actives will generally provide additional water that must be accounted for in the equation.

The next step is to form the organic solvent system. An effective amount of at least one organic solvent is provided. Although the organic solvent system can comprise a combination of organic solvents, in this case, 38.38% dipropylene glycol will entirely make up the organic solvent system of Example 1.

The next step is to provide a water-soluble dye after addition of the organic solvent system, generally before the addition of the optional adjunct ingredients and/or the thickener. In this case, 0.14% Direct Blue 86 Solution is provided before the optional adjunct ingredients.

The next step is to provide optional adjunct ingredients which include: 3.70% C14 amine oxide, 4.63% SLF18®, 21.80% G100 sodium carbonate, 1.41% BRITESIL H2O®, 0.16% LIQUIBLU 4® perfume, 1.60% FN3 enzyme slurry and 2.00% NATALASE® enzyme prill.

Since the amine oxide solution is comprised of only 20% actives, the amine oxide itself will add approximately 2.96% water to the reaction. Thus, the amount of water to be added to theoretically fully hydrate the STPP to produce 100% STPP*6H2O is reduced to 3.61%. An Alcohol Quench Method can be used to determine the amount of STPP that is actually converted to STPP*6H2O. Generally, the conversion rate is about 72% on average for this example when the amount of water added is determined by the above chemical equation.

The next step is to form an agglomerate. The 25.98% Hydrated Intermediate Powder, the 3.7% C14 amine oxide, 38.38% dipropylene glycol, 0.14% Direct Blue 86 Solution and the adjunct ingredients are mixed together in a batch mixer to form an agglomerate. The agglomerate is then placed in the dispersion mill mix tank (Union Process Q-Attritor or IKA's Dispax Reactor DRS2000) and continually recirculated to reduce the particle size of the solids to between about 10 and about 70 microns as measured using a Hegman Gauge.

A thickener can then be added once the particle size of the solids have been reduced to the proper size range. 0.02% Methocel OS is added to the dispersion tank and the mix is recirculated through the mill to fully disperse the thickening material.

Additional optional adjunct ingredients may be added to the dispersion tank prior to or after the addition of the thickener to finish the product. These optional adjunct ingredients may be selected from the group consisting of free radical inhibitors, wetting agents, polymers, soil release agents, anti-filming agents, anti-spotting agents, suds suppressors, hydrotropes, germicides, fungicides, color speckles, bleach scavengers, dishcare agents, and mixtures thereof. Recirculation continues until the optional adjunct ingredients are fully dispersed. The composition is then allowed to thicken.

After the batch thickens, the recirculation is stopped. The yield value of the resulting batch will be between about 5 Pa and about 35 Pa, preferably from about 10 to about 20, more preferably from about 12 to about 17, most preferably about 15. The finished product is a free flowing gel that can be easily poured or dosed into a pouching mold or into a bottle. The final step is pouring or dosing the thickened composition in a container (e.g. bottle or pouch mold).

Not to be bound by theory, it has been surprisingly found that the same components when prepared in a different order will lead to a product with an unacceptable yield value. For example, if the liquid materials are first mixed together in a mix tank and then the dry materials are subsequently added to the liquid mixture to form an agglomerate. The resulting agglomerate is then recirculated in a dispersion mill mix tank (Union Process Q-Attritor or IKA's Dispax Reactor DRS2000) to reduce the particle size of all the solids to between about 10 and about 70 microns as measured using a Hegman Gauge. After the particle size outlined above is met, the Methocel OS is then added to the dispersion tank and the mix is recirculated through the mill to fully disperse the material. The remaining materials (i.e. adjunct material) are added to the dispersion tank and recirculated to ensure uniform mixing to finish the product. The composition is allowed to thicken and the recirculation is stopped. The yield value of the resulting composition will be greater than 100 Ps. The finished product will be more a solid than a gel and cannot be easily poured or dosed into a pouching mold or out of a bottle.

It has also been surprisingly found that even if the method and order of addition is followed as outlined in Example 1, but that a greater amount of water is added to the components than is needed to convert the STPP to 100% STPP*6H2O according to the equation, then the yield value of the resulting batch will be greater than 100 Pa. The finished product will be more a solid than a gel and cannot be easily poured or dosed into a pouching mold or out of a bottle.

In one non-limiting embodiment of the present invention, a method for manufacturing an organic solvent composition for use in automatic dishwashing, the order of addition for the method for manufacturing comprises the steps of: (a) providing an effective amount of sodium tripolyphosphate (STPP); (b) mixing said STPP and water in a mixer to form a hydrated intermediate powder comprising STPP*6H2O such that the phosphate in said hydrated intermediate powder is at least 30% hydrated by weight; (c) providing an effective amount of said hydrated intermediate powder; (d) providing an effective amount of at least one organic solvent; (e) mixing said component(s) of step (d) in a mix tank to form said organic solvent system; (f) optionally, providing and adding an effective amount of an adjunct ingredient; (g) adding said hydrated intermediate powder and said optional adjunct ingredients to said organic solvent system together in a dispersion mill mix tank for mixing; (h) recirculating the components in said dispersion mix tank through a mill until the particle size of all the solids has been reduced to between about 10 and about 70 microns as measured using a Hegman Gauge; (i) providing and adding an effective amount of a water-soluble dye selected from the group consisting of azo dye, stilbene dye, phthalocyanine dye, triphenodioxazine dye, formazan dye, anthraquinone dye, and mixtures thereof; (j) providing and adding an effective amount of a thickener to said components once said particle size of said solids have been reduced; (k) mixing and recirculating said components until said thickener and said water-soluble dye is fully dispersed; (1) allowing said composition to thicken; (m) stopping the recirculation of said dispersion mill; (n) optionally measuring the yield value of a sample of said anhydrous organic solvent composition to ensure that the yield value of said anhydrous organic solvent composition has a range of from about 10 to about 20 Pa; and (o) pouring or dosing said composition in a container;

wherein said effective amount of water is calculated by the following formula:

STPP+6H2O→STPP*6H2O,

and wherein said composition is in the form of a liquid gel.

Organic Solvent System

The anhydrous organic solvent composition comprises an organic solvent composition (wherein “solvent composition” is understood to comprise the organic solvent system and optional additional active ingredients and diluents) and one or more automatic dishwashing detergent compositions. The anhydrous organic solvent composition can be built, unbuilt or generally unbuilt. By “generally unbuilt” is meant that the composition contains less than about 5% by weight of a detergency builder.

The organic solvent system should be selected so as to be compatible with the tableware, as well as with, the different parts of an automatic dishwashing machine. The individual organic solvents used herein generally have a boiling point above about 150° C., flash point above about 100° C. and vapor pressure below about 1 mm Hg, preferably below 0.1 mm Hg at 25° C. at atmospheric pressure. The organic solvent is present at any suitable amount, and is typically present at levels from about 10% to about 80% by weight of the total composition.

The organic solvent system is preferably formulated to meet the constraints on volatile solvent components. In highly preferred, non-limiting embodiments, the organic solvent system will contain from about 10% to about 80%, preferably from about 20% to about 70%, and more preferably from about 30% to about 50% of solvent components having a vapor pressure above about 0.1 mm Hg at 25° C. at atmospheric pressure. In other highly preferred, non-limiting embodiments, the solvent is essentially free (contains less than about 5% by weight) of solvent components having a boiling point below about 150° C., flash point below about 100° C. or a vapor pressure above about 1 mm Hg at 25° C. at atmospheric pressure.

The organic solvents used in the composition can also be described in terms of their Hansen solubility parameters which are know to those skilled in the art. Hansen solubility parameters were developed to characterize solvents for the purpose of comparison. Each of three parameters (i.e., dispersion, polar, and hydrogen bonding) represents a different characteristic of solvency. In combination, the three parameters are a measure of the overall strength and selectivity of a solvent. The total Hansen solubility parameter, which is the square root of the sum of the squares of the three parameters mentioned previously, provides a more general description of the solvency of organic solvents.

In terms of solvent parameters, the organic solvent of the present invention can be selected from (a) polar, hydrogen-bonding solvents having a Hansen solubility parameter of at least 20 (Mpa)^{1/2}, a polarity parameter of at least 7 (Mpa)^{1/2}, preferably at least 12 (Mpa)^{1/2} and a hydrogen bonding parameter of at least 10 (Mpa)^{1/2}; (b) polar non-hydrogen bonding solvents having a Hansen solubility parameter of at least 20 (Mpa)^{1/2}, a polarity parameter of at least 7 (Mpa)^{1/2}, preferably at least 12 (Mpa)^{1/2} and a hydrogen bonding parameter of less than 10 (Mpa)^{1/2}; (c) amphiphilic solvents having a Hansen solubility parameter below 20 (Mpa)^{1/2}, a polarity parameter of at least 7 (Mpa)^{1/2} and a hydrogen bonding parameter of at least 10 (Mpa)^{1/2}; and (d) non-polar solvents having a polarity parameter below 7 (Mpa)^{1/2} and a hydrogen bonding parameter below 10 (Mpa)^{1/2}, and mixtures thereof.

Examples of suitable solvents that can be used herein include but are not limited to: i) alcohols, such as benzyl alcohol, 1,4-cyclohexanedimethanol, 2-ethyl-1-hexanol, furfuryl alcohol, 1,2-hexanediol and other similar materials; ii) amines, such as alkanolamines (e.g. primary alkanolamines: monoethanolamine, monoisopropanolamine, diethylethanolamine, ethyl diethanolamine; secondary alkanolamines: diethanolamine, diisopropanolamine, 2-(methylamino)ethanol; ternary alkanolamines: triethanolamine, triisopropanolamine); alkylamines (e.g. primary alkylamines: monomethylamine, monoethylamine, monopropylamine, monobutylamine, monopentylamine, cyclohexylamine), secondary alkylamines: (dimethylamine), alkylene amines (primary alkylene amines: ethylenediamine, propylenediamine) and other similar materials; iii) esters, such as ethyl lactate, methyl ester, ethyl acetoacetate, ethylene glycol monobutyl ether acetate, diethylene glycol monoethyl ether acetate, diethylene glycol monobutyl ether acetate and other similar materials; iv) glycol ethers, such as ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol butyl ether and other similar materials; v) glycols, such as propylene glycol, diethylene glycol, hexylene glycol (2-methyl-2, 4 pentanediol), triethylene glycol, composition and dipropylene glycol and other similar materials; and mixtures thereof.

The organic solvent system is preferably selected from i) glycol ethers, such as ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol butyl ether and other similar materials; and ii) glycols, such as propylene glycol, diethylene glycol, hexylene glycol (2-methyl-2, 4 pentanediol), triethylene glycol, composition and dipropylene glycol and other similar materials; and mixtures thereof.

In one non-limiting embodiment, the automatic dishwashing detergent composition is in the form of a liquid gel comprising from about 10% to about 80%, preferably from about 20% to about 70%, most preferably from about 30% to about 50%, by weight, of a non-aqueous organic solvent, preferably dipropylene glycol.

Hydratable Builders

Phosphate Builder

Phosphate builders include, but are not limited to, the alkali metal, ammonium and alkanolammonium salts of polyphosphates (exemplified by the tripolyphosphates, pyrophosphates, and glassy polymeric meta-phosphates). Phosphate builder sources are described in detail in Kirk Othmer, 3rd Edition, Vol. 17, pp. 426-472 and in “Advanced Inorganic Chemistry” by Cotton and Wilkinson, pp. 394-400 (John Wiley and Sons, Inc.; 1972).

A preferred phosphate builder salt is sodium tripolyphosphate (STPP). The STPP can be a blend of anhydrous STPP and a small amount of STPP hexahydrate such that the chemically bound water content corresponds to six H₂O molecules per pentasodium tripolyphosphate molecule. Such STPP may be produced by treating anhydrous STPP with a limited amount of water. The presence of the hexahydrate slows down the rapid rate of solution of the STPP in the wash bath and inhibits caking. One suitable STPP is sold under the name THERMPHOS™ NW. The particles size of the THERMPHOS™ NW STPP, as supplied, is usually averages 200 microns with the largest particles being 400 microns.

One aspect of the invention relates to the use of hydrated STPP. The hydrated STPP used in one non-limiting embodiment of the present invention is preferably the hexahydrate form. Hydrated STPP is commercially available, however, it is expensive and generally not completely hydrated (e.g. it is only partially hydrated). A separate rehydration stage is generally required as a separate step in the process. Thus use of anhydrous STPP or partially hydrated STPP in the rehydration step is preferred. The effective amount of water in the organic solvent composition is determined by the amount of hexahydrate generated. The uptake of moisture through the water-soluble pouch containing the organic solvent composition is related to the amount of water present in the composition.

Since sodium tripolyphosphate hexahydrate is less readily soluble in water than potassium tripolyphosphate, the use of sodium tripolyphosphate hexahydrate is preferred over potassium tripolyphosphate. Sodium tripolyphosphate hexahydrate provides a heterogeneous character to the resulting gels giving a higher structural viscosity. This so-called high structural viscosity decreases considerably at relatively high spindle speeds and increases considerably at low spindle speeds. The viscosity measurements were carried out using a Contraves™ rotational cup & bob viscosimeter. The viscosities of the cleaning agents used in accordance with the invention extend up to 25,000 Pa.s, @ 1 s−1 as measured at a temperature of 25° C.

In one non-limiting embodiment of the present invention, sodium tripolyphosphate is typically present at a level of from about 5% to about 70% by weight, preferably from about 7% to about 50% by weight, most preferably from about 10% to about 30% by weight of composition.

Citrate Builder

Like phosphate builders, citrate builders are classified as sequestering builders and dissolve rapidly to form complexes with hardness ion. Although phosphate forms much more stable complexes with hardness ions, in regions where phosphate builders cannot be used, citrate builders are generally practiced.

Citrate builders include, but are not limited to, potassium and sodium salts of citrate. A preferred citrate builder is sodium citrate. One aspect of the invention relates to the use of hydrated sodium citrate, such that the chemically bound water content corresponds to two H₂O per sodium citrate molecule.

The hydrated sodium citrate used in one non-limiting embodiment of the present invention is preferably the dihydrate form. Sodium citrate dihydrate, like STPP hexahydrate, provides a heterogeneous character to the resulting gels giving a higher structural viscosity. Since sodium citrate dihydrate is less soluble in water than the potassium salt and does not form a monohydrate like potassium citrate, the sodium salt is preferred over the potassium salt. In one non-limiting embodiment of the present invention, sodium citrate is typically present at a level of from about 5% to about 70% by weight, preferably from about 7% to about 50% by weight, most preferably from about 10% to about 30% by weight of composition.

Effective Amount of Water

The effective amount of water, preferably deionized water, in the anhydrous organic solvent composition of the present invention is determined by the amount of hydrated builder species to be generated. The uptake of moisture through the water-soluble pouch containing the anhydrous organic solvent composition is related to the amount of water present in the composition itself. For example, anhydrous solvent compositions generally exhibit a higher uptake of moisture than aqueous solvent compositions in water-soluble pouches. Without being bound by any particular theory, it is believed that water transportation through the pouch wall can be driven by a high gradient due to the presence of the source of alkalinity (e.g. carbonate).

For example, the effective amount of water for the phosphate builder, STPP, is calculated by the following chemical equation: STPP+6H2O→STPP*6H2O, wherein the “STPP*6H2O” represents sodium tripolyphosphate hexahydrate. For example, if the composition contains 22.37% STPP, the total amount of water needed to convert the STPP to 100% STPP*6H2O is 6.57%. Note that some water will come from the stock material. If the stock material is 20% active, then 2.96% water is derived from the stock material alone. The balance 3.61% water will be added to the composition to deliver a product yield value of from about 5 to about 10, generally about 7.

Moisture Content

Comparative analyses were completed on products comprising fully anhydrous organic solvent compositions. In one embodiment of the present invention, an anhydrous organic solvent composition is pouched in MONOSOL® 8630 PVA film supplied by Monosol, a division of Chris Craft International, Gary, Ind., U.S.A., on the vertical heat sealer, placed in both sealed and un-sealed plastic tubs with snap on lids. A total of hundred pouches each are placed in the following environments: 80° F./80% RH, 80° F./15% RH, and ambient (˜70° F./26% RH). At the increments of 1, 2, 4, and 6 weeks the following characteristics were assessed: moisture content/pick-up, enzyme activity, pouch weight, pouch feel, phase stability, and relative pouch dissolution. Additionally girth-height measurements of the pouches were taken with modified calipers to obtain an indirect reading of the volume changes due to moisture pickup associated with the different environments under which the pouches are subjected. In addition, temperature and humidity are tracked throughout the experiment via use of HOBO® data loggers.

As is seen in Table I below, the pouches at 80% relative humidity shows the largest average gain in weight (and >30% girth-height increase) after 6 weeks in unsealed tubs. Comparison of the results indicates that humidity is a large driver of the weight change. Higher humidity allows for more water pick-up, resulting in excessive pouch swelling and consumer dissatisfaction. Enzyme activities are also at unacceptable levels at the higher humidity.

TABLE I

| | Ambient | | |
|---|---|---|---|
| | 70° F., 26% Rel. | 80° F., 15% Rel. | 80° F., 80% Rel. |
| | Humidity | Humidity | Humidity |
| Week | % Weight Change | % Weight Change | % Weight Change |
| 1 | 0.397% | 0.06% | 1.20% |
| 2 | 0.529% | 0.005% | 2.11% |
| 4 | 1.15% | 0.44% | 3.96% |
| 6 | 1.52% | 1.49% | 5.96% |

It has been surprisingly found that the present invention shows significantly less weight gain over the same period than the anhydrous compositions tested above. Without being bound by any particular theory, it is believed to be largely due to the requiring the pre-hydration of STPP to form the hydrate intermediate powder prior to adding or mixing with other components. Without being bound by any particular theory, it is also believed that at least 30% hydration of the phosphate by weight of the hydrated intermediate powder controls the moisture content of the anhydrous organic solvent composition in a water-soluble pouch by decreasing the gradient, thus minimizing the swelling caused by excessive moisture uptake during unsealed storage.

In one non-limiting embodiment of the present invention, the phosphate in the hydrated intermediate powder is at least 50% hydrated, preferably, at least 75% hydrated, most preferably at least 90% hydrated by weight of the hydrated intermediate powder.

In one non-limiting embodiment of the present invention, the hydrated intermediate powder comprises from about 7% to about 50% by weight of the total composition.

Water-Soluble Dye

Though the compositions described herein can include water-insoluble dyes, water-soluble dyes, or mixtures thereof, water-soluble dyes are preferred. The anhydrous organic solvent composition of the present invention comprises water-soluble dyes at any suitable amount, and typically at least 0.00005% by weight of the total composition.

Readily water-soluble dyes or fluorescent brighteners are to be understood as meaning dyes or fluorescent brighteners having a solubility in water of >100 g/125° C. Suitable water-soluble dyes are primarily textile dyes of all kinds of chemical classes. They are for example anionic dyes, such as nitro, aminoketone, ketone-imine, methine, nitrodiphenylamine, quinoline, aminonaphthaquinone or coumarin dyes or even acid dyes based on fustic extract, in particular acid anthraquinone and azo dyes, such as monoazo and disazo dyes. These dyes contain at least one anionic water-solubilising group, for example a carboxyl or in particular a sulfo group. The dyes are generally in their salt form, for example in the form of the lithium, sodium, potassium or ammonium salt. Also possible are basic, i.e. cationic, dyes and stilbene dyes. Examples thereof are the halides, sulfates, methosulfates or metal halide salts, for example tetrachlorozincates, of azo dyes, such as monoazo, disazo and polyazo dyes, and of anthraquinone dyes, phthalocyanine dyes, diphenylmethane and triarylmethane dyes, methine, polymethine and azomethine dyes and of thiazole, ketone-amine, acridine, cyanine, nitro, quinoline, benzimidazole, xanthene, azine, oxazine and thiazine dyes. These basic dyes are commercially available under a wide variety of different names.

In one non-limiting embodiment of the present invention, the anhydrous organic solvent composition comprises at least 0.00005%, preferably at least 0.0005%, most preferably at least 0.001% by weight of the total composition, of a water-soluble dye. Preferred water-soluble dyes can be selected from the group consisting of azo dye, stilbene dye, phthalocyanine dye, triphenodioxazine dye, formazan dye, anthraquinone dye, and mixtures thereof.

Thickener

The anhydrous organic solvent composition comprises a thickener at any suitable amount. The thickener is typically present at a level from about 0.1% to about 0.7% by weight of the total composition.

Suitable thickening agents include inorganic clays (e.g. LAPONITE®, aluminium silicate, bentonite, fumed silica), natural gum and cellulosic type thickeners. The preferred clay thickening agent can be either naturally occurring or synthetic. Preferred synthetic clays include the synthetic smectite-type clay sold under the trademark LAPONITE® by Southern Clay Products, Inc., Gonzales, Tex., U.S.A. Particularly useful are gel-forming grades such as LAPONITE RD® and sol forming grades such as LAPONITE RDS®. Natural occurring clays include some smectite and attapulgite clays. Mixtures of clays and polymeric thickeners are also suitable for use herein.

Suitable natural gum thickeners include, for example, xanthan gum, locust bean gum, guar gum, and the like. Preferred thickeners are the cellulosic type thickeners: hydroxyethyl and hydroxymethyl cellulose (ETHOCEL® and METHOCEL® available from Dow Chemical) can also be used. The compositions preferably are in liquid gel-form and contain a thickener such as methylcellulose or other nonionic cellulosic thickener.

In one non-limiting embodiment of the present invention, the thickener is selected from the group consisting of inorganic clay, natural gum, cellulosic type thickeners, and mixtures thereof.

### Adjunct Ingredients

The anhydrous organic solvent composition of the present invention will generally be built and can comprise one or more detergent active components which may be selected from colorants, bleaching agents, surfactants, alkalinity sources, enzymes, thickeners (in the case of liquid, paste, cream or gel compositions), anti-corrosion agents (e.g. sodium silicate), hydrotropes (e.g. sodium cumene sulfate) and disrupting agents. Highly preferred components include other organic solvents, wetting agents, alkalinity sources, co-builders, enzymes, surfactants, suds suppressors, bleaching systems, and mixtures thereof.

Other Organic Solvents

The solvent compositions herein can further comprise one or more organic solvents having a cleaning function, carrier or diluent function, or combinations thereof. For example, anhydrous organic solvent compositions of the present invention can comprise water and other volatile solvents as carriers. Low quantities of low molecular weight primary or secondary alcohols such as methanol, ethanol, propanol and isopropanol can also be used in the liquid detergent of the present invention as cleaners, carriers or diluents. Other suitable carrier solvents used in low quantities includes glycerol, propylene glycol, ethylene glycol, 1,2-propanediol, sorbitol, and mixtures thereof.

Wetting Agent

The effect of the organic solvent system can be further improved by the addition of certain wetting agents. Preferably, the organic solvent system is used in conjunction with a wetting agent that is effective in lowering the surface tension of the organic solvent system, preferably to at least 1 mN/m less than that of the wetting agent, the wetting agent preferably being selected from organic surfactants having a surface tension less than about 30 mN/m, more preferably less than about 28 mN/m and specially less than about 26 mN/m. Preferred wetting agents for use herein are silicone polyether copolymers, especially silicone poly(alkyleneoxide) copolymers wherein alkylene is selected from ethylene, propylene, and mixtures thereof.

Source of Alkalinity

The anhydrous organic solvent composition of the present invention can have any suitable pH. To provide an alkaline pH, the anhydrous organic solvent composition may comprise an alkalinity source. Generally, the alkalinity source raises the pH of the anhydrous organic solvent composition to at least 10.0 in a 1 wt-% aqueous solution and preferably to a range of from about 10.5 to 14. Such pH is sufficient for soil removal and sediment breakdown when the chemical is placed in use and further facilitates the rapid dispersion of soils. The general character of the alkalinity source is limited only to those chemical compositions which have a substantial aqueous solubility. Exemplary alkalinity sources include an alkali metal silicate, hydroxide, phosphate, or carbonate. The alkalinity source can include an alkali metal hydroxide including sodium hydroxide, potassium hydroxide, lithium hydroxide, etc.

Mixtures of these hydroxide species can also be used. Alkaline metal silicates can also act as a source of alkalinity for the detergents of the invention. Useful alkaline metal silicates correspond with the general formula (M₂O:SiO₂) wherein for each mole of M₂O there is less than one mole of SiO₂. Preferably for each mole of SiO₂ there is from about 0.2 to about 100 moles of M₂O wherein M comprises sodium and/or potassium. Preferred sources of alkalinity are alkaline metal orthosilicate, alkaline metal metasilicate, and other well known detergent silicate materials.

The alkalinity source can include an alkali metal carbonate. Alkali metal carbonates that may be used in the invention include sodium carbonate, potassium carbonate, sodium and/or potassium bicarbonate or sesquicarbonate, silicate, and mixtures thereof among others. Preferred carbonates include sodium and potassium carbonates. These sources of alkalinity can be used the detergents of the invention at any suitable concentration, including but not limited to from about 0 wt-% to about 50 wt-%, preferably from about 5 wt-% to about 40 wt-%, and most preferably from about 10 wt-% to about 30 wt-%.

Co-Builder

All builders suitable for use in ADD compositions are suitable herein as co-builders. The co-builder of the present invention may be present in any suitable amount, and is typically present at a level of from about 1% to about 80% by weight, preferably from about 10% to about 70% by weight, most preferably from about 20% to about 60% by weight of the total composition.

For example, the present invention may include, but are not limited to, the following builders: amorphous sodium silicates, aluminosilicates, magnesioaluminosiliates, alkali metal, phosphates, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulfates, citrate, zeolite and/or layered silicate, alkaline earth and alkali metal carbonates, polycarboxylate compounds, ether hydroxypolycarboxylates, copolymers of maleic anhydride with ethylene or vinyl methyl ether, 1, 3, 5-trihydroxy benzene-2, 4, 6-trisulphonic acid, and carboxymethyloxysuccinic acid, the various alkali metal, ammonium and substituted ammonium salts of polyacetic acids, such as ethylenediaminetetraacetic acid and nitrilotriacetic acid, as well as polycarboxylates, such as mellitic acid, succinic acid, oxydisuccinic acid, polymaleic acid, benzene 1,3,5-tricarboxylic acid, carboxymethyloxysuccinic acid, and soluble salts thereof, and citrate co-builders, such as citric acid and soluble salts thereof (particularly sodium salt).

Phosphate builders include, but are not limited to, the alkali metal, ammonium and alkanolammonium salts of polyphosphates (exemplified by the tripolyphosphates, pyrophosphates, and glassy polymeric meta-phosphates). Phosphate builder sources are described in detail in Kirk Othmer, Encyclopedia of Chem. Tech, 3rd Edition, Vol. 17, pp. 426-472 and in “Advanced Inorganic Chemistry” by Cotton and Wilkinson, pp. 394-400 (John Wiley and Sons, Inc.; 1972).

In one non-limiting embodiment of the present invention, the co-builder is selected from the group consisting of phosphate, phosphate oligomers or polymers and salts thereof, silicate, silicate oligomers or polymers and salts thereof, aluminosilicates, magnesioaluminosiliates, citrate, and mixtures thereof.

Enzyme

The anhydrous organic solvent compositions herein may further comprise one or more enzymes. Preferred enzymes are hydrolases such as proteases, amylases and lipases. Highly preferred for automatic dishwashing are amylases and/or proteases, including both current commercially available types and improved types which, though more bleach compatible, have a remaining degree of bleach deactivation susceptibility.

If only one enzyme is used, it is preferably an amyolytic enzyme. Highly preferred for automatic dishwashing is a mixture of proteolytic enzymes and amyloytic enzymes. More generally, the enzymes to be incorporated include proteases, amylases, lipases, cellulases, and peroxidases, as well as mixtures thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, co-builders, etc. In this respect bacterial or fungal enzymes are preferred, such as bacterial amylases and proteases, and fungal cellulases.

Enzymes are normally incorporated in the instant detergent compositions at levels sufficient to provide a “cleaning-effective amount”. The term “cleaning-effective amount” refers to any amount capable of producing a cleaning, stain removal or soil removal effect on substrates such as fabrics, dishware and the like. Since enzymes are catalytic materials, such amounts may be very small.

In practical terms for current commercial preparations, typical amounts are up to about 5 mg by weight, more typically about 0.01 mg to about 3 mg, of active enzyme per gram of the composition. Protease enzymes are usually present in such commercial preparations at levels sufficient to provide from 0.005 to 0.1 Anson units (AU) of activity per gram of composition, preferably 0.01%-1% by weight of a commercial enzyme preparation.

Enzyme-containing compositions, especially liquid, liquid gel and gel compositions, herein may comprise from about 0.0001% to about 10%, preferably from about 0.005% to about 8%, most preferably from about 0.01% to about 6%, by weight of an enzyme stabilizing system. The enzyme stabilizing system can be any stabilizing system which is compatible with the detersive enzyme. Such stabilizing systems can comprise calcium ion, boric acid, propylene glycol, short chain carboxylic acid, boronic acid, and mixtures thereof.

For automatic dishwashing purposes, it may be desirable to increase the active enzyme content of the commercial preparations, in order to minimize the total amount of non-catalytically active materials delivered and thereby improve spotting/filming results.

In a non-limiting embodiment of the present invention, the anhydrous organic solvent composition comprises from about 0.0001% to about 2% by weight of the total composition, of an enzyme stabilizing system.

Surfactant

The anhydrous organic solvent composition may also comprise one or more detergent surfactants including but not limited to anionic surfactants, cationic surfactants, nonionic surfactants, amphoteric surfactants, ampholytic surfactants, zwitterionic surfactants, and mixtures thereof. In compositions and methods of the present invention for use in cleaning soiled tableware prior to dishwashing, the detergent surfactant is preferably foamable in direct application but low foaming in automatic dishwashing use (e.g. low foaming by itself or in combination with other components such as suds suppressors).

Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, preferably C₁₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants, and mixtures thereof including nonionic alkoxylated surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC®) by the BASF-Wyandotte Corp., Wyandotte, Mich.; amphoteric surfactants such as the C₁₂-C₂₀ alkyl amine oxides (for example, amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/08874.

Surfactants can be present in any suitable amount, and are typically present at a level of from about 0.2% to about 30% by weight, more preferably from about 0.5% to about 10% by weight, most preferably from about 1% to about 5% by weight of the total composition.

In one non-limiting embodiment of the present invention, the anhydrous organic solvent composition comprises from about 0% to about 30% by weight, of a surfactant selected from the group consisting of anionic surfactants, cationic surfactants, nonionic surfactants, amphoteric surfactants, ampholytic surfactants, zwitterionic surfactants, and mixtures thereof. In another non-limiting embodiment of the present invention, the surfactant is amine oxide at a level of about 0.5% to about 20%, by weight.

Suds Suppressor

Preferred surfactants for use herein are low foaming and include low cloud point nonionic surfactants and mixtures of higher foaming surfactants with low cloud point nonionic surfactants which act as suds suppressors therein (see EP-A-0705324).

Typical low cloud point nonionic surfactants which act as suds suppressors include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., Olin Corporation's POLY-TERGENT® SLF18) and epoxy-capped poly(oxyalkylated) alcohols (e.g., Olin Corporation's POLY-TERGENT® SLF18B series of nonionics, as described, for example, in U.S. Pat. No. 5,576,281).

Preferred low cloud point surfactants are the ether-capped poly (oxyalkylated) suds suppressor having the formula:

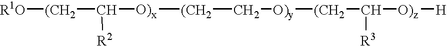

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:

R_{I}O(R_{II}HO)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:

(i) a 4 to 8 membered substituted, or unsubstituted heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

Suds suppressors are present at any suitable amount, and are typically present at a level of from about 0.2% to about 30% by weight, more preferably from about 0.5% to about 10% by weight, most preferably from about 1% to about 5% by weight of the total composition.

Bleaching System

The anhydrous organic solvent composition may comprise a bleaching system, present in any suitable amount, and typically present at a level from about 0% to about 25%. In one non-limiting embodiment of the present invention the bleaching system may comprise a bleach, a bleach catalyst, a bleach activator, and mixtures thereof. In another non-limiting embodiment of the present invention, the anhydrous organic solvent composition can comprise the bleaching system in any suitable amount. The bleaching system is typically present from about 0% to about 15%, preferably from about 1% to about 10%, more preferably from about 2% to about 6%, by weight of the total composition.

Bleaching agents suitable herein include chlorine and oxygen bleaches, especially inorganic perhydrate salts such as sodium perborate mono-and tetrahydrates and sodium percarbonate optionally coated to provide controlled rate of release (see, for example, GB-A-1466799 on sulfate/carbonate coatings), preformed organic peroxyacids, and mixtures thereof with organic peroxyacid bleach precursors and/or transition metal-containing bleach catalysts (especially manganese or cobalt).

Peroxygen bleaching compounds can be any peroxide source, and is preferably a member selected from the group consisting of sodium perborate monohydrate, sodium perborate tetrahydrate, sodium pyrophosphate peroxyhydrate, urea peroxyhydrate, sodium percarbo-nate, sodium peroxide and mixtures thereof. Highly preferred peroxygen bleaching compounds are selected from the group consisting of sodium perborate monohydrate, sodium perborate tetrahydrate, sodium percarbonate and mixtures thereof.

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt (III) and related complexes (U.S. Pat. No. 4,810,410) at any suitable amount, and typically at levels from 0% to about 10.%; preferably from 0.1% to 1.0% by weight of the total composition.

Typical bleach activators preferred for use herein include peroxyacid bleach precursors, precursors of perbenzoic acid and substituted perbenzoic acid; cationic peroxyacid precursors; peracetic acid precursors such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482807) at any suitable amount, and typically at levels from 0% to about 10.%; preferably from 0.1% to 1.0% by weight of the total composition.

Other bleach activators include to substituted benzoyl caprolactam bleach activators and their use in bleaching systems and laundry detergents. The substituted benzoyl caprolactams have the formula:

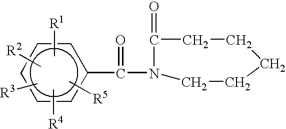

wherein R¹, R², R³, R⁴, and R⁵ contain from 1 to 12 carbon atoms, preferably from 1 to 6 carbon atoms and are members selected from the group consisting of H, halogen, alkyl, alkoxy, alkoxyaryl, alkaryl, alkaryloxy, and members having the structure:

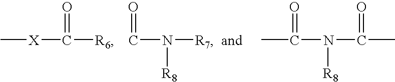

wherein R₆ is selected from the group consisting of H, alkyl, alkaryl, alkoxy, alkoxyaryl, alkaryloxy, and aminoalkyl; X is O, NH, or NR₇, wherein R₇ is H or a C₁-C₄ alkyl group; and R₈ is an alkyl, cycloalkyl, or aryl group containing from 3 to 11 carbon atoms; provided that at least one R substituent is not H.

In a non-limiting embodiment, R¹, R², R³, and R⁴ are H and R⁵ is selected from the group consisting of methyl, methoxy, ethyl, ethoxy, propyl, propoxy, isopropyl, isopropoxy, butyl, tert-butyl, butoxy, tert-butoxy, pentyl, pentoxy, hexyl, hexoxy, Cl, and NO₃. In another preferred embodiment, R¹, R², R³ are H, and R⁴ and R⁵ are members selected from the group consisting of methyl, methoxy, and Cl.

In a non-limiting embodiment of the present invention the bleaching system comprises:

a) from about 0% to about 15% by weight, preferably from about 2% to about 6% by weight, of a peroxygen bleaching compound capable of yielding hydrogen peroxide in an aqueous solution;

b) from about 0% to about 1.0% by weight, of one or more substituted benzoyl caprolactam bleach activators having the formula:

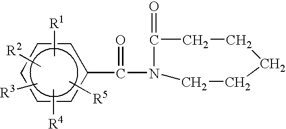

wherein R¹, R², R³, R⁴, and R⁵ are as defined above.

Other Suitable Components

The anhydrous organic solvent composition can further comprise antiredopsition agents, free radical inhibitors, polymers, soil release agents, anti-filming agents, anti-spotting agents, hydrotropes, germicides, fungicides, color speckles, bleach scavengers, dishcare agents, and mixtures thereof.

The compositions herein can contain a corrosion inhibitor such as organic silver coating agents at any suitable level, and typically present at levels of from about 0.05% to about 10%, preferably from about 0.1% to about 5% by weight of the total composition (especially paraffins such as Winog 70 sold by Wintershall, Salzbergen, Germany), nitrogen-containing corrosion inhibitor compounds (for example benzotriazole and benzimadazole—see GB-A-1137741) and Mn(II) compounds, particularly Mn(II) salts of organic ligands in levels of from about 0.005% to about 5%, preferably from about 0.01% to about 1%, more preferably from about 0.02% to about 0.4% by weight of the total composition.

Organic polymers having dispersant, anti-redeposition, soil release or other detergency properties can be present in the instant invention at any suitable amount, and typically at levels of from about 0.1% to about 30%, preferably from about 0.5% to about 15%, most preferably from about 1% to about 10% by weight of the total composition. Preferred anti-redeposition polymers herein include acrylic acid containing polymers such as Sokalan PA30, PA20, PA15, PA10 and Sokalan CP10 (BASF GmbH), Acusol 45N, 480N, 460N (Rohm and Haas), acrylic acid/maleic acid copolymers such as Sokalan CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol, and mixtures thereof.

Heavy metal sequestrants and crystal growth inhibitors are suitable for use herein at any suitable amount, and are typically present at levels generally from about 0.005% to about 20%, preferably from about 0.1% to about 10%, more preferably from about 0.25% to about 7.5% and most preferably from about 0.5% to about 5% by weight of the total composition, for example diethylenetriamine penta (methylene phosphonate), ethylenediamine tetra(methylene phosphonate) hexamethylenediamine tetra(methylene phosphonate), ethylene diphosphonate, hydroxy-ethylene-1,1-diphosphonate, nitrilotriacetate, ethylenediaminotetracetate, ethylenediamine-N,N′-disuccinate in their salt and free acid forms.

Other suitable components herein include water-soluble bismuth compounds such as bismuth acetate and bismuth citrate at any suitable amount, typically present at levels of from about 0.01% to about 5%, enzyme stabilizers such as calcium ion, boric acid, propylene glycol and chlorine bleach scavengers can be present at any suitable amount and typically are present at levels of from about 0.01% to about 6%, lime soap dispersants (see WO-A-93/08877), colorants, optical brighteners, perfumes, fillers and clay.

Water-Soluble Pouch

It is a feature of the invention that many of the organic solvent systems and compositions of the invention that are optimum for cleaning also demonstrate improved compatibility with partially hydrolysed, water-soluble PVA pouch materials of known construction and type. This is particularly surprising given that many well-known polar/or hydrolysed bonding solvent materials (for example the organoamines) in themselves have low compatibility with PVA materials and present serious issues for product stability.

The anhydrous organic solvent composition can be in any physical form, e.g. liquid, paste, cream, gel, liquid gels and similarly the automatic dishwashing detergent composition can be in any of these forms. Preferably, however, both compositions are in the form of liquids, liquid gels and/or gels. The compositions used herein can be dispensed from any suitable device, such as bottles (pump assisted bottles, squeeze bottles), paste dispensers, capsules, multi-compartment bottles, multi-compartment capsules, and single- and multi-compartment water-soluble pouches. Single- and multi-compartment water-soluble pouches are preferred. In the case of additive and multi-component products, the invention does not require the two compositions to be in the same physical form.

EXAMPLE 1

| Material | Weight % |
|---|---|
| Hydrated Intermediate Powder | |
| STPP | 22.37 |
| DI Water | 3.61 |
| Finished Product | |
| Dipropylene Glycol | 38.38 |
| SLF-18 | 4.63 |
| C14 Amine Oxide | 3.70 |
| DI Water | 0.00 |
| G100 Sodium Carbonate | 21.80 |
| Hydrated Intermediate Powder | 25.98 |
| Britesil H20 | 1.41 |
| BHT | 0.00 |
| Methocel OS Thickener | 0.20 |
| Sodium Perborate Monohydrate | 0.00 |
| LiquiBlu 4 Perfume | 0.16 |
| Direct Blue 86 Soln | 0.14 |
| FN3 Enzyme Slurry | 1.60 |
| Natalase Enzyme Prill | 2.00 |
| TOTAL | 100.00 |

What is claimed is:

1. A method for manufacturing an anhydrous organic solvent composition for use in automatic dishwashing, the steps of the method for manufacturing comprising:
a) providing an effective amount of a hydratable builder selected from the group consisting of sodium tripolyphosphate (STPP), sodium citrate, and mixtures thereof;
b) mixing said hydratable builder with an effective amount of water in a mixer to form a hydrated intermediate powder comprising hydrated builder, such that the phosphate, citrate, or mixture thereof in said hydrated intermediate powder is at least 30% hydrated by weight;
c) providing an effective amount of an organic solvent system;
d) mixing said hydrated intermediate powder and said organic solvent system together in a dispersion mill mix tank to reduce the particle size of the solids to between about 10 and about 70 microns as measured using a Hegman Gauge;
e) providing and adding a water-soluble dye to said dispersion mill mix tank;
f) providing and adding a thickener to said dispersion mill mix tank;
g) recirculating the components in said dispersion mill mix tank until said thickener and dye are fully dispersed in said composition;
h) allowing said composition to thicken; and
i) pouring or dosing said thickened composition in a container;
wherein said composition is in the form of a liquid gel; and wherein the yield value of said composition has a range of from about 5 to about 35 Pa.

2. A method for manufacturing according to claim 1, wherein said hydratable builder is sodium tripolyphosphate (STPP); and wherein said effective amount of water is calculated by the following formula:
STPP+6H2O→STPP*6H2O.

3. A method for manufacturing according to claim 2, wherein said phosphate in said hydrated intermediate powder is at least 75% hydrated by weight of said hydrated intermediate powder.

4. A method for manufacturing according to claim 3, wherein said phosphate in said hydrated intermediate powder is at least 90% hydrated by weight of said hydrated intermediate powder.

5. A method for manufacturing according to claim 1, wherein said hydrated intermediate powder comprises from about 7% to about 50% by weight of the total composition.

6. A method for manufacturing according to claim 1, wherein said water-soluble dye comprises at least 0.0005% by weight of the total composition, and wherein said water-soluble dye is selected from the group consisting of azo dye, stilbene dye, phthalocyanine dye, triphenodioxazine dye, formazan dye, anthraquinone dye, and mixtures thereof;

7. A method for manufacturing according to claim 6, wherein said organic solvent system comprises from about 20% to about 70% by weight of the total composition.

8. A method for manufacturing according to claim 1 wherein said organic solvent system is selected from:
a) polar, hydrogen-bonding solvents having a Hansen solubility parameter of at least 20 (Mpa)^{1/2}, a polarity parameter of at least 7 (Mpa)^{1/2}, preferably at least 12 (Mpa)^{1/2} and a hydrogen bonding parameter of at least 10 (Mpa)^{1/2};
b) polar non-hydrogen bonding solvents having a Hansen solubility parameter parameter of at least 20 (Mpa)^{1/2}, a polarity parameter of at least 7 (Mpa)^{1/2}, preferably at least 12 (Mpa)^{1/2} and a hydrogen bonding parameter of less than 10 (Mpa)^{1/2};
c) amphiphilic solvents having a Hansen solubility parameter below 20 (Mpa)^{1/2}, a polarity parameter of at least 7 (Mpa)^{1/2} and a hydrogen bonding parameter of at least 10 (Mpa)^{1/2};
d) non-polar solvents having a polarity parameter below 7 (Mpa)^{1/2} and a hydrogen bonding parameter below 10 (Mpa)^{1/2}; and
e) mixtures thereof.

9. A method for manufacturing according to claim 1 wherein said organic solvent system is selected from the group consisting of glycols and glycol derivatives, glycol ethers, glycol esters, and mixtures thereof.

10. A method for manufacturing according to claim 9 wherein said glycol is dipropylene glycol.

11. A method for manufacturing according to claim 1, wherein said thickener comprises from about 0.1% to about 0.7% by weight of the total composition, wherein said thickener is selected from the group consisting of inorganic clay, natural gum, cellulosic type thickeners, and mixtures thereof.

12. A method for manufacturing according to claim 1, wherein said method for manufacturing further comprises the steps of providing from about 0% to about 30% by weight of a surfactant prior to step (d) and then mixing said components of step (d) with said surfactant, wherein said surfactant is selected from the group consisting of anionic surfactants, cationic surfactants, nonionic surfactants, amphoteric surfactants, ampholytic surfactants, zwitterionic surfactants, and mixtures thereof.

13. A method for manufacturing according to claim 12, wherein said surfactant is amine oxide.

14. A method for manufacturing according to claim 1, wherein said method for manufacturing further comprises the steps of providing and adding an effective amount of an adjunct ingredient prior to step (d), wherein said adjunct ingredient is selected from the group consisting of a source of alkalinity, enzyme, co-surfactant, perfume, bleach, bleach catalyst, anti-oxidant, free radical inhibitors, wetting agent, polymers, soil release agents, anti-filming agents, anti-spotting agents, antiredeposition agent, suds suppressors, hydrotropes, germicides, fungicides, color speckles, bleach scavengers, dishcare agents, and mixtures thereof.

15. A method for manufacturing according to claim 1, wherein said container comprises a member selected from the group consisting of bottles, paste dispensers, capsules, multi-compartment bottles, multi-compartment capsules, and single- and multi-compartment water-soluble pouches, and combinations thereof.

16. A method for manufacturing according to claim 15, wherein said container is a water-soluble pouch selected from the group consisting of said single-compartment pouch, multi-compartment water-soluble pouch, and combinations thereof.

17. A method for manufacturing an organic solvent composition for use in automatic dishwashing, the order of addition for said method for manufacturing comprising the steps of:
a) providing an effective amount of sodium tripolyphosphate (STPP);
b) mixing said STPP and water in a mixer to form a hydrated intermediate powder comprising STPP*6H2O such that the phosphate in said hydrated intermediate powder is at least 30% hydrated by weight;
c) providing an effective amount of said hydrated intermediate powder;
d) providing an effective amount of at least one organic solvent;
e) mixing said component(s) of step (d) in a mix tank to form said organic solvent system;
f) optionally, providing and adding an effective amount of an adjunct ingredient;
g) adding said hydrated intermediate powder and said optional adjunct ingredients to said organic solvent system together in a dispersion mill mix tank for mixing;
h) recirculating the components in said dispersion mix tank through a mill until the particle size of all the solids has been reduced to between about 10 and about 70 microns as measured using a Hegman Gauge;
i) providing and adding an effective amount of a water-soluble dye selected from the group consisting of azo dye, stilbene dye, phthalocyanine dye, triphenodioxazine dye, formazan dye, anthraquinone dye, and mixtures thereof;
j) providing and adding an effective amount of a thickener to said components once said particle size of said solids have been reduced;
k) mixing and recirculating said components until said thickener and said water-soluble dye is fully dispersed;
l) allowing said composition to thicken;
m) stopping the recirculation of said dispersion mill;
n) optionally measuring the yield value of a sample of said anhydrous organic solvent composition to ensure that the yield value of said anhydrous organic solvent composition has a range of from about 10 to about 20 Pa; and
o) pouring or dosing said composition in a container;
wherein said effective amount of water is calculated by the following formula:
STPP+6H2O→STPP*6H2O,
and wherein said composition is in the form of a liquid gel.

18. A method for manufacturing according to claim 17, wherein said organic solvent system is selected from the group consisting of glycols and glycol derivatives, glycol ethers, glycol esters, and mixtures thereof.

19. A method for manufacturing according to claim 17, further comprising an adjunct ingredient selected from the group consisting of a source of alkalinity, enzyme, surfactant, co-surfactant, perfume, bleaching system, bleach activator, bleach catalyst, anti-oxidant, free radical inhibitors, wetting agent, polymers, soil release agents, anti-filming agents, anti-spotting agents, antiredeposition agent, suds suppressors, hydrotropes, germicides, fungicides, color speckles, bleach scavengers, dishcare agents, and mixtures thereof

20. A method for manufacturing according to claim 19, wherein said surfactant is selected from the group consisting of anionic surfactants, cationic surfactants, nonionic surfactants, amphoteric surfactants, ampholytic surfactants, zwitterionic surfactants, and mixtures thereof.
